(19) United States
(12) Patent Application Publication
(10) Pub. No.: US 2026/0181589 A1
(43) Pub. Date: Jun. 25, 2026

(54) METHOD AND ELECTRONIC MODULE FOR DETECTING THE INDOOR OR OUTDOOR POSITION OF AN ELECTRONIC DEVICE

(71) Applicant: FONDATION B-COM, Cesson Sevigne (FR)

(72) Inventors: Hamidreza KHALEGHI, Cesson-Sevigne (FR); Thierry LUCIDARME, Livre-Sur-Changeon (FR)

(21) Appl. No.: 19/423,748

(22) Filed: Dec. 17, 2025

(30) Foreign Application Priority Data
Dec. 20, 2024 (FR) 2414951

(51) Int. Cl. H04W 64/00; H04B 17/26; H04B 17/27; H04B 17/309; H04B 17/318; H04B 17/336

(52) U.S. Cl. CPC H04W 64/006; H04B 17/26; H04B 17/27; H04B 17/318; H04B 17/336; H04B 17/346

(57) ABSTRACT

A method, and associated electronic module, for detecting the indoor or outdoor position of an electronic device exchanging a signal carried by electromagnetic waves with a remote telecommunication system, the method including measuring a value of a quantity characteristic of the signal exchanged, applying the measured value at the input of a Kalman filter outputting a filtered estimation of said quantity, comparing a statistical value determined as a function of said filtered estimation with a threshold in order to detect the indoor or outdoor position of the electronic device.

### TECHNICAL FIELD OF THE INVENTION

The present invention relates to the technical field of telecommunications.

In particular, the invention relates to a method for detecting the indoor and outdoor position of an electronic device, and an associated electronic module.

### STATE OF THE ART

It has already been tried, for instance in the article “Indoor outdoor user discrimination in mobile wireless networks” by E. Villebrun, A. Ben Hadj Alaya, Y. Boursier and N. Noisette, in IEEE Vehicular Technology Conference, September 2006, to detect the indoor or outdoor position of a mobile terminal, in order, for example, to allocate to it particular resources of the telecommunication network depending on the estimated position.

Such techniques are relatively simple to implement, but their reliability is limited, which reduces their practical value.

Solutions based on artificial intelligence have been proposed, but they require significant calculation resources, which also makes them difficult to use in practice.

### DISCLOSURE OF THE INVENTION

In this context, the invention provides a method for detecting the indoor or outdoor position of an electronic device (e.g. a mobile terminal) exchanging a signal carried by electromagnetic waves with a remote telecommunication system, the method comprising the following steps:
measuring a value of a quantity characteristic of the signal exchanged;
applying the measured value at the input of a Kalman filter outputting a filtered estimation of said quantity;
comparing a statistical value determined as a function of said filtered estimation with a threshold in order to detect the indoor or outdoor position of the electronic device.

The Kalman filter can be easily implemented and provides improved detection robustness.

The statistical value can depend for example on a likelihood ratio of two statistical hypotheses representing respectively the indoor positions and the outdoor positions of the electronic device.

The above-mentioned quantity can be a logarithm of a ratio between a useful strength of the signal and a strength of disturbances affecting this signal. This quantity is for example a logarithm of a signal-to-interference-plus-noise ratio, or a signal-to-noise ratio. According to other possible embodiments, the quantity can be a strength of the received signal, or the received power of a reference signal, or also the logarithm of one of these quantities.

The above-mentioned comparison can used in practice a generalized likelihood ratio test.

As explained in the following description, the statistical value can in certain embodiments be calculated by squaring up the difference between the filtered estimation and a predetermined value, which allows a very simple implementation.

The threshold can be determined as a function of a desired false alarm rate.

The method can comprise a step during which resources of a telecommunication network comprising the remote telecommunication system are allocated to the electronic device, based on the estimated position.

The invention also provides an electronic module for detecting the indoor or outdoor position of an electronic device exchanging a signal carried by electromagnetic waves with a remote telecommunication system, characterized by:
a Kalman filter configured to receive (as an input) a value of a quantity characteristic of the signal exchanged and to produce (as an output) a filtered estimation of said quantity;
a comparison unit configured to compare a statistical value determined as a function of said filtered estimation with a threshold in order to detect the indoor or outdoor position of the electronic device.

The comparison unit can be configured to calculate the statistical value by squaring up the difference between the above-mentioned filtered estimation and a predetermined value, as in the example described hereinafter.

The electronic module can be integrated in the electronic device or in the remote telecommunication system, or even in another electronic device.

### DETAILED DESCRIPTION OF THE INVENTION

Moreover, various other features of the invention emerge from the appended description made with reference to the drawings that illustrate non-limiting embodiments of the invention, and wherein:

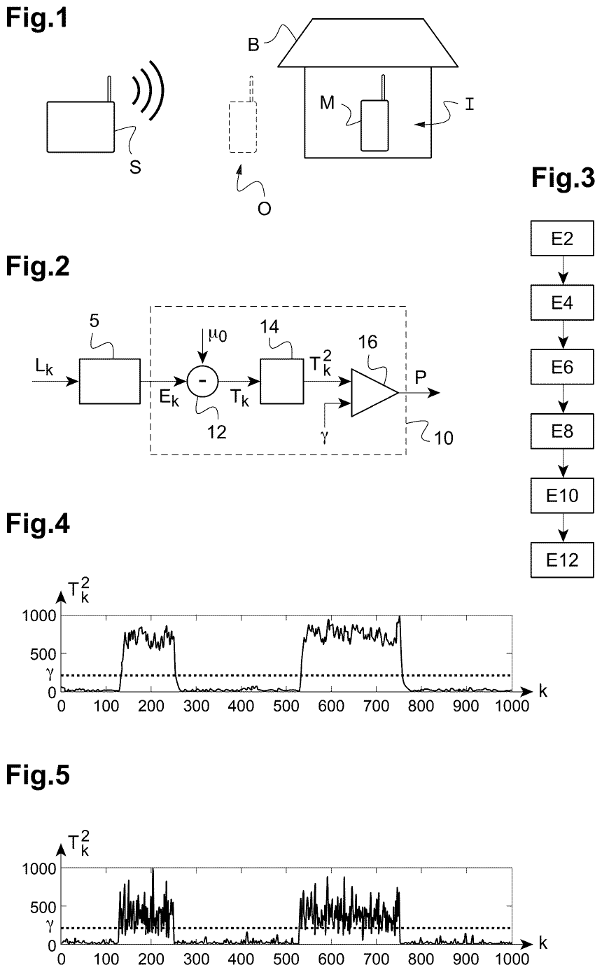

FIG. 1 is a diagram showing a context of use of the invention;

FIG. 2 shows elements in an electronic module for detecting the indoor or outdoor position of an electronic device;

FIG. 3 is a flow diagram showing the steps of a method for detecting this indoor or outdoor position;

FIG. 4 shows the evolution of a statistical value used within the electronic module of FIG. 2, which includes a Kalman filter; and

FIG. 5 shows the evolution of the same statistical value in the absence of the Kalman filter.

In FIG. 1 is schematically shown a possible context of implementation of the invention.

An electronic device M (here a mobile terminal, or “user equipment” according to the terminology used in certain standards) and a telecommunication system S (here a base station of a mobile telecommunication network), remote from the electronic device M, exchange between them signals carried by electromagnetic waves transmitted by the telecommunication system S and received by the electronic device M, or conversely, transmitted by the electronic device M and received by the telecommunication system S.

As explained hereinafter, it is here searched to determine if the electronic device M is located inside a (any) building B (i.e. in an indoor environment) or outside any building (i.e. in an outdoor environment), in other words to detect the indoor position I or outdoor position O of the electronic device M.

Such a detection is carried out by an electronic module as described hereinafter with reference to FIG. 2 based on a value (obtained by measurement) of a quantity characteristic of a signal exchanged between the electronic device M and the telecommunication system S.

This characteristic quantity is for example a ratio between a useful strength of the signal and a strength of disturbances affecting this signal, such as the Signal-to-Interference-plus-Noise Ratio (SINR), or in practice the logarithm of such a ratio. Other quantities are also usable (as well as the logarithm of these quantities) such as the difference between the uplink Signal-to-Interference-plus-Noise Ratio (Uplink SINR) and the downlink Signal-to-Interference-plus-Noise Ratio (Downlink SINR), or the Signal-to-Noise Ratio (SNR), or the Received Signal Strength Indicator (RSSI), or also the Reference Signal Received Power (RSRP). As will become clear in the following, a quantity whose values follow a Gaussian (or normal) probability (or distribution) law is preferably used.

Such an electronic module can belong to the telecommunication system S, or the electronic device M, or also another electronic device (distinct from the telecommunication system S and the electronic device M).

The measurement of the quantity characteristic of the signal exchanged can be carried out by the electronic entity (telecommunication system S, or electronic device M, or another electronic device) that integrates the electronic module.

For example, when the electronic device M transmits a signal towards the telecommunication system S and the telecommunication system S integrates the electronic module, the telecommunication system S can measure the quantity characteristic of the signal received from the electronic device M, so that the electronic module (made for example in accordance with FIG. 2 as described hereinafter) can detect the indoor or outdoor position of the electronic device M based on the measured values.

As an alternative, the measurement of the characteristic quantity of the signal exchanged can be carried out by another electronic entity than the electronic unit in which the electronic module is integrated, in which case this other electronic entity transmits the measured values to the electronic entity integrating the electronic module.

For example, in case of transmission of a signal by the telecommunication system S and reception of this signal by the electronic device M, the electronic device M can measure a quantity characteristic of the received signal and transmit the measured values to the telecommunication system S so that an electronic module integrated to the telecommunication system S and made in accordance with what is described hereinafter with reference to FIG. 2 detects the indoor or outdoor position of this electronic device M based on measured values received by the telecommunication system S.

FIG. 2 shows the elements of an electronic module for detecting the indoor or outdoor position of an electronic device.

This electronic module comprises a Kalman filter 5 and a comparison unit 10.

The Kalman filter 5 receives as an input successive values Lₖ (respectively associated with different measurement time instants) of a quantity characteristic of the signal exchanged so as to produce as an output (for each of the measurement time instants) a filtered estimation Eₖ of this characteristic quantity.

This characteristic quantity is here the logarithm of the Signal-to-Interference-plus-Noise Ratio (SINR).

For each measurement time instant (or in other words, for each value Lₖ of the characteristic quantity), the Kalman filter 5 carries out:
a prediction phase during which the filtered estimation Eₖ₋₁ obtained for the previous time instant is used as state prediction E^{p}ₖ for the current time instant (E^{p}ₖ=Eₖ₋₁) and during which the prediction P^{p}ₖ of the state variance for the current time instant is obtained by adding an evolution variance Q (or “process variance”) to the state variance estimated at the previous time instant Pₖ₋₁, i.e. P^{p}ₖ=Pₖ₋₁+Q (the evolution variance Q being for example determined as a function of the measurement noise variance R, with here Q=0, 1. R);
an updating phase during which the Kalman gain K is determined as the ratio between the prediction P^{p}ₖ of the state variance and the sum of this prediction P^{p}ₖ and of the measurement noise variance R (K=P^{p}ₖ/(P^{p}ₖ+R)), during which the filtered estimation Eₖ is obtained by adding to the state prediction E^{p}ₖ the product of the Kalman gain K and the difference obtained by subtracting the state prediction E^{p}ₖ from the value Lₖ received at the input of the Kalman filter 5 (Eₖ=E^{p}ₖ+K·(Lₖ−E^{P}ₖ)), and during which the state variance Pₖ is estimated by multiplying the prediction P^{p}ₖ of the state variance by a factor obtained by subtracting the Kalman gain from the number 1: Pₖ=(1−K)·P^{p}ₖ (all these values being relative to the current time instant, marked by the index k).

The state estimated in this Kalman filter 5 is thus the characteristic quantity itself.

To determine the current filtered estimation Eₖ, the Kalman filter 5 uses here only values relative to the previous and current time instants, and the electronic module therefore does not need to store a history of past values (as could be the case using other filtering solutions).

The comparison unit 10 is designed to compare a statistical value Tₖ² determined as a function of said filtered estimation Eₖ with a threshold in order to detect the indoor or outdoor position of the electronic device M.

It is considered here that the values of the filtered estimation Eₖ can follow two distinct probability distributions according to whether the electronic device M has an indoor position or an outdoor position:
in the hypothesis H₀ in which the electronic device M is outdoor, the values of the filtered estimation Eₖ follow a Gaussian distribution of mean value (or expectation) μ₀ and standard deviation σ₀ (or, in other word, variance σ₀²),
in the hypothesis H₁ in which the electronic device M is indoor, the values of the filtered estimation Eₖ follow a Gaussian distribution of mean value (or expectation) μ₁ and standard deviation σ₁ (or, in other word, variance σ₁²).

The statistical metric Tₖ=Eₖ−μ₀ is introduced (this statistical metric Tₖ being therefore the difference between the filtered estimation Eₖ and the mean value μ₀).

The probability densities of Gaussian distributions can then be written as:
for the hypothesis H₀ (outdoor electronic device M):

$$P ( {T}_{k} \vert {H}_{0} ) = \frac{1}{\sqrt{2 π {σ}_{0}^{2}}} exp ( - \frac{{T}_{k}^{2}}{2 {σ}_{0}^{2}} )$$

for the hypothesis H₁ (indoor electronic device M):

$$P ( {T}_{k} \vert {H}_{1} ) = \frac{1}{\sqrt{2 π {σ}_{1}^{2}}} exp ( - \frac{{( {T}_{k} - Δ μ )}^{2}}{2 {σ}_{1}^{2}} )$$

with Δμ=μ₁−μ₀.

To detect the indoor position (hypothesis H₁) or outdoor (hypothesis H₀) of the electronic device M, the comparison unit 10 uses the Neyman-Pearson decision criterion:

$$\begin{matrix}{H}_{1} \\ Λ \begin{matrix}> \\ <\end{matrix} η \\ {H}_{0}\end{matrix}$$

where η is a threshold regulating the false alarm rate and A the likelihood ratio:

$$Λ = \frac{P ( {T}_{k} \vert {H}_{1} )}{P ( {T}_{k} \vert {H}_{0} )} = \frac{{σ}_{0}}{{σ}_{1}} exp ( \frac{{T}_{k}^{2}}{2 {σ}_{0}^{2}} - \frac{{( {T}_{k} - Δ μ )}^{2}}{2 {σ}_{1}^{2}} )$$

The comparison unit 10 here uses the Generalized Likelihood Ratio Test (GLRT), which takes the criterion defined above, setting certain parameters to estimated values of these parameters, here parameters Δ_{μ}, σ₀ and σ₁:
the parameter [symbol] is estimated by the estimator of the Maximum Likelihood Estimate (MLE) in the hypothesis H₁:

$$= {arg max}_{Δμ} \frac{1}{\sqrt{2 π {σ}_{1}^{2}}} exp ( - \frac{{( {T}_{k} - Δ μ )}^{2}}{2 {σ}_{1}^{2}} ) = {T}_{k}$$

the standard deviations are considered equal to each other and to a same estimated value \hat{σ}: σ₀=σ₁=\hat{σ}.

The values \hat{σ} and μ₀ can be estimated by previous tests or during a calibration phase.

In other words, the comparison unit 10 applies the Neyman-Pearson criterion defined hereinabove with σ₀=σ₁=\hat{σ} and Δ_{μ}=Tₖ, so that the likelihood ratio can be written as:

$$Λ = exp ( \frac{{T}_{k}^{2}}{2 {\hat{σ}}^{2}} )$$

and the test carried out by the comparison unit 10 amounts to the following comparison:

$$\begin{matrix}{H}_{1} \\ {T}_{k}^{2} \begin{matrix}> \\ <\end{matrix} 2 {\hat{σ}}^{2} ln ( η ) \\ {H}_{0}\end{matrix}$$

The statistical variable Tₖ² follows a Chi-square distribution with one degree of freedom under hypothesis H₀:

$$\frac{{T}_{k}^{2}}{{\hat{σ}}^{2}} ∼ {χ}^{2} ( 1 )$$

and the test carried out by the comparison unit 10 can thus be written as:

$$\begin{matrix}{H}_{1} \\ {T}_{k}^{2} \begin{matrix}> \\ <\end{matrix} {\hat{σ}}^{2} {χ}_{1 - α}^{2} ( 1 ) \\ {H}_{0}\end{matrix}$$

where α is the false alarm rate and

$${χ}_{1 - α}^{2} ( 1 )$$

corresponds to the (1-α)-quantile of the Chi-squared distribution with one degree of freedom.

The comparison unit 10 comprises a subtraction block 12 that subtracts the value μ₀ from the filtered estimation Eₖ received at the input of the comparison unit 10 so as to obtain the value Tₖ of the metric introduced hereinabove.

The comparison unit 10 also comprises a squaring block 14 that receives the value Tₖ produced by the subtraction block 12 and outputs the statistical value Tₖ².

The comparison unit 10 finally comprises a comparison block 16 that receives the statistical value Tₖ² produced by the squaring block 14, compares this statistical value Tₖ² with a threshold γ and outputs the estimated position P as a function of the result of the comparison carried out:
if the statistical value Tₖ² is greater than the threshold γ, the estimated position P indicates that the electronic device M is located inside a building,
if the statistical value Tₖ² is below the threshold γ, the estimated position P indicates that the electronic device M is located outdoor.

As explained hereinabove, the threshold value γ used herein is the product of the estimated standard deviation \hat{σ} and the value

$${χ}_{1 - α}^{2} ( 1 )$$

of the (1-α)-quantile of the Chi-squared distribution with one degree of freedom, where α is the false alarm rate. The threshold γ thus here depends on the desired false alarm rate.

FIG. 3 is a flow diagram showing the steps of a method for detecting this indoor or outdoor position.

This method is here partly implemented in the electronic module that has just been described with reference to FIG. 2. More precisely, here, steps E6 to E10 described hereinafter are implemented by the electronic module of FIG. 2.

The method starts with a step E2 of measuring a value Lₖ of a quantity characteristic of the exchanged signal.

The case considered here is for example the case in which the electronic device M receives a signal carried by an electromagnetic wave transmitted by the telecommunication system S and in which the electronic device M measures (at different successive time instants) a value Lₖ of the logarithm of the Signal-to-Interference-plus-Noise Ratio (SINR) of the received signal.

It is moreover considered here that the electronic module of FIG. 2 belongs to the telecommunication module S.

The method then comprises a step E4 (here carried out by the electronic device M) of transmitting the value Lₖ to the telecommunication system S so that this value Lₖ is available for being processed by the electronic module of FIG. 2.

This electronic module can then apply the value Lₖ at the input of the Kalman filter 5, which enables to produce the corresponding filtered estimation Eₖ at the output of the Kalman filter 5 (step E6).

The comparison module 10 determines (using the subtraction block 12 and the squaring block 14) the statistical value Tₖ² as a function of the filtered estimation Eₖ (step E8).

As explained hereinabove, the statistical value Tₖ² is here calculated by squaring up the difference between the filtered estimation Eₖ and the value μ₀.

The comparison module 10 then compares the statistical value Tₖ² with the threshold γ defined hereinabove (step E10) in order to determine the estimated (indoor or outdoor) position P of the electronic device M.

The method of FIG. 3 can possibly comprise thereafter a step E12 of allocating resources (provided by a telecommunication network comprising the communication system S) to the electronic device M, this allocation being made as a function of the estimated position P.

In order to clearly show the benefits of using the Kalman filter in the electronic module of FIG. 2, FIGS. 4 and 5 show the evolution of the statistical value Tₖ² respectively when this electronic module is used and when a similar electronic module with no Kalman filter is used.

More precisely, each of FIGS. 4 and 5 show the statistical values Tₖ² successively obtained for 1000 measurement time instants (i.e. k varying from 1 to 1000) while the electronic device M passes through outdoor environments (detected by Tₖ²<γ) and indoor environments (detected by Tₖ²>γ). In these figures, the threshold γ used is that which is obtained from the formulas given hereinabove for a false alarm rate of 0.1%.

As shown in FIGS. 4 and 5, the presence of the Kalman filter in the electronic module of FIG. 2 increases significantly the detection robustness.

The above description is only a possible embodiment of the invention.

In particular, in order to further improve the robustness, it is possible to use an aggregated statistical value obtained by summing n successive values Tₖ² and to compare this aggregated statistical value

$${\sum }_{k} {T}_{k}^{2}$$

with a threshold to determine the indoor or outdoor position of the electronic device M. The threshold is in this case based on the Chi-square distribution with n degrees of freedom χ²(n).

1. A method for detecting an indoor position or an outdoor position of an electronic device exchanging a signal carried by electromagnetic waves with a remote telecommunication system, the method comprising:
measuring a value of a quantity characteristic of the exchanged signal;
applying the measured value at an input of a Kalman filter outputting a filtered estimation of said quantity;
comparing a statistical value determined as a function of said filtered estimation with a threshold; and
detecting the indoor position or the outdoor position of the electronic device based on a result of the comparing.

2. The method according to claim 1, wherein the statistical value depends on a likelihood ratio of two statistical hypotheses respectively representing the indoor position and the outdoor position of the electronic device.

3. The method according to claim 1, wherein said quantity is a logarithm of a ratio between a useful strength of the signal and a strength of disturbances affecting the signal.

4. The method according to claim 3, wherein said quantity is a logarithm of a signal-to-interference-plus-noise ratio.

5. The method according to claim 1, wherein said comparing uses a generalized likelihood ratio test.

6. The method according to claim 1, wherein the threshold is determined as a function of a desired false alarm rate.

7. The method according to claim 1, further comprising allocating resources, of a telecommunication network comprising the remote telecommunication system, to the electronic device, based on the detected position.

8. An electronic system for detecting an indoor position or an outdoor position of an electronic device exchanging a signal carried by electromagnetic waves with a remote telecommunication system, the electronic system comprising:
a Kalman filter configured to receive a value of a quantity characteristic of the signal exchanged and output a filtered estimation of said quantity; and
circuitry configured to compare a statistical value determined as a function of said filtered estimation with a threshold in order to detect the indoor position or the outdoor position of the electronic device.

9. The electronic system according to claim 8,
wherein the statistical value depends on a likelihood ratio of two statistical hypotheses respectively representing the indoor position and the outdoor position of the electronic device.

10. The electronic system according to claim 8, wherein the electronic system is configured to be integrated into said electronic device.

11. The electronic system according to claim 8, wherein the electronic system is configured to be integrated into said remote telecommunication system.
